(19) United States
(12) Patent Application Publication
(10) Pub. No.: US 2014/0280605 A1
(43) Pub. Date: Sep. 18, 2014

(54) Systems and Methods for Automatic Sharing, Synchronizing and Collaboration of Information among Users of a Group

(71) Applicant: FutureWei Technologies, Inc., Plano, TX (US)

(72) Inventor: Jianyu Zhang, Santa Clara, CA (US)

(21) Appl. No.: 14/212,296

(22) Filed: Mar. 14, 2014

Related U.S. Application Data
(60) Provisional application No. 61/800,586, filed on Mar. 15, 2013.

(51) Int. Cl. H04L 29/08

(52) U.S. Cl. CPC H04L 67/1095
USPC 709/205

(57) ABSTRACT

Embodiments are provided for automatic sharing, synchronizing and collaboration of information among users of a group. In an embodiment, a method includes updating information located on a member device, and determining whether the information is marked for sharing with the members of the group. The updated information marked for sharing is automatically compared with a copy of the information at a server in a network. If the updated information is newer than the copy at the server, the updated information is uploaded to the server via a cloud service. When the device is turned on or connects to the network, the device automatically checks with the server whether there is newer sharable information at the server than a corresponding copy on the device or there is a push message marked to be sent to the device, and synchronizes the copy on the device with the newer information at the server.

This application claims the benefit of U.S. Provisional Application No. 61/800,586 filed on Mar. 15, 2013 by Jianyu Zhang and entitled “Method and System for Automatic Sharing and Synchronizing of Information among Users of a Group,” which is hereby incorporated herein by reference as if reproduced in its entirety.

### TECHNICAL FIELD

The present invention relates to the field of network communications, and, in particular embodiments, to systems and methods for automatic sharing, synchronizing and collaboration of information among users of a group.

### BACKGROUND

Electronic devices (e.g., desktop computers, laptops, tablet computers, smartphones) are playing an increasing role in people's everyday lives for both business and social activities. The devices also include wearable smart devices such as Smartwatch™, Google Glass™, or other sensor and interactive devices. In groups such as a work or social group (e.g., project team, company, family, friends), some information is of common interest to all members of the group and thus is shared and used by all group members. For example, in a family, the family members need to know the contact information (e.g., phone number) for relatives or friends of parents or spouses, but they are often informed of changes to the contact information of only immediate relatives. Thus, some family members' contact lists are not updated in a timely manner to reflect changes to the contact information of others outside of their immediate relatives. Currently, services offered by service providers are limited to sharing and updating the contacts of the social group members. However, these services do not share and update the related information of the social group members. Further, such services do not automatically share and update information among members. In view of the above, there is a need for a way to continuously update critical information which is shared by a group among the members and accessible using the members' mobile communication devices.

### SUMMARY OF THE INVENTION

In accordance with an embodiment, a method performed by a communication device for sharing, synchronizing and collaboration of information among a group of members includes updating information located on the communication device associated with one of the members, and determining whether the information is marked for sharing with the members of the group. The method further includes, upon detecting that the information is marked for sharing, automatically comparing the updated information with a copy of the information at a server in a network. Upon detecting that the updated information is newer than the copy of the information at the server, the updated information is uploaded to the server via a cloud service.

In accordance with another embodiment, a method performed by a communication device for sharing, synchronizing and collaboration of information among a group of members includes updating information located on the communication device, and determining whether the information is marked for sharing with the members of the group. Upon detecting that the information is marked for sharing, the communication device detects other devices associated with other members of the group using a peer-to-peer protocol. The method further includes sending a push message to the devices of the other members via the peer-to-peer protocol. The push message notifies the devices that the information at the communication device has been updated.

In accordance with another embodiment, a method performed by a server supporting sharing, synchronizing and collaboration of information among a group of members includes receiving, via a cloud service, updated information from a device associated with a member of the group. The update information is sharable by the members of the group. The method further includes sending a push message to other devices of other members of the group. The push message notifies the other members of the updated information at the device. The updated information is then synchronized with corresponding copies at the other devices.

In accordance with yet another embodiment, a communication device supporting sharing, synchronizing and collaboration of information among a group of members comprises at least one processor and a non-transitory computer readable storage medium storing programming for execution by the at least one processor. The programming includes instructions to update information located on the communication device associated with one of the members, and determine whether the information is marked for sharing with the members of the group. Upon detecting that the information is marked for sharing, the communication device is configured to compare the updated information with a copy of the information at a server in a network, and upon detecting that the updated information is newer than the copy of the information at the server, upload the updated information to the server via a cloud service.

In accordance with another embodiment, a communication device supporting sharing, synchronizing and collaboration of information among a group of members comprises at least one processor and a non-transitory computer readable storage medium storing programming for execution by the at least one processor. The programming includes instructions to update information located on the communication device, and determine whether the information is marked for sharing with the members of the group. Upon detecting that the information is marked for sharing, the device is configured to detect devices associated with other members of the group using a peer-to-peer protocol, and send a push message to the devices of the other members via the peer-to-peer protocol. The push message notifies the devices that the information at the communication device has been updated.

In accordance with yet another embodiment, a network server supporting sharing, synchronizing and collaboration of information among a group of members comprises at least one processor and a non-transitory computer readable storage medium storing programming for execution by the at least one processor. The programming includes instructions to receive, via a cloud service, updated information from a device associated with a member of the group. The update information is sharable by the members of the group. The programming includes further instructions to send a push message to other devices of other members of the group. The push message notifies the other members of the updated information at the device. The device is further configured to synchronize the updated information with corresponding copies at the other devices.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a block diagram of a system for sharing, synchronizing and collaboration of information between electronic devices according to an embodiment of the disclosure;

FIG. 2 is a block diagram showing the structure and operation of the system for sharing, synchronizing and collaboration of information between electronic devices according to an embodiment of the disclosure;

FIGS. 3A and 3B illustrate a flow chart showing a method for sharing, synchronizing and collaboration of information between electronic devices according to an embodiment of the disclosure;

FIGS. 4A, 4B and 4C illustrate a flow chart showing a method for sharing, synchronizing and collaboration of information between electronic devices according to another embodiment of the disclosure;

FIG. 5 is a block diagram of a system for sharing, synchronizing and collaboration of information between electronic devices according to another embodiment of the disclosure;

FIG. 6 is a block diagram showing the structure and operation of the system for sharing, synchronizing and collaboration of information between electronic devices according to another embodiment of the disclosure;

FIGS. 7A, 7B and 7C illustrate a flow chart showing a method for sharing, synchronizing and collaboration of information between electronic devices according to another embodiment of the disclosure; and

FIG. 8 is a block diagram of a mobile communications device that can be used to implement various embodiments; and

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

In available collaboration software, such as Google Docs™, after a group logs into a session, changes to a document made by one member is visible to another person in the same session. However, existing collaboration software typically requires all members to be connected in order to obtain the most recent version of the documentation change. Also, existing collaboration software typically shares information among any users that sign onto the session and thus is not very secure. Further, existing collaboration software requires a cloud service to host a “collaboration room”.

Disclosed herein are illustrative embodiments of systems and methods for sharing, synchronizing and collaboration of information that is commonly used by a plurality of members in a group. The systems and methods automatically share and update the members' commonly used or shared information so that the members have access to and are able to use up-to-date information via their electronic devices. As used herein, the term automatically indicates that a method step can be performed by the electronic device with minimal or no user input or interaction. However, in some embodiments, the step may still request confirmation from the user to proceed with or cancel the step.

The group of members generally consists of users with a common relationship or affiliated with a common organization, such as a work or business group, a social group, a family group, or other groups. The commonly used information generally consists of information associated with a member of the group but is of interest or used by other members of the group as well. The information can belong to a member of the group or is kept or maintained by a member of the group. The information is not limited to the member's own information, such as a member's own phone number or address, but also includes such information for other persons outside the group, e.g., persons related in some way to a member of the group, which needs to be known by all members of the group. As such, all members can use the newest copies of the information. The information may be data, documents, and/or any relevant information to the members. The information may have at least one of a date stamp, a mark indicating if it is to be shared, and a mark indicating which group(s) the information is shared for.

The embodiments are described in detail below. Some of the embodiments enable the sharing, synchronized and collaboration of information between group members via a cloud environment (e.g., networking over the Internet). Other embodiments enable the sharing, synchronizing and collaboration of information between group members via a peer-to-peer network or connection without a cloud environment. The commonly used information (e.g. contacts, calendar, documents, project status, customer contact number or order status, photos, multimedia files, playlists memos, notes, or other shareable information) between group members are automatically shared and synchronized using member devices via cloud, peer-to-peer, or other suitable networking. The term automatically is used herein to refer to actions taken by the described system components without user intervention (except to update or use information on his/her device). The information that needs to be shared commonly in the group may belong to a member or may be kept or changed by a member. For example, the information may be kept by a member (not the member's own information) and belong to an individual outside the group. The sharing and updating (or synchronizing) enables all members of the group to use the newest version or copy of the information. The up-to-date or newest information can be obtained anytime, e.g., while the device is online or offline, and each member can have his/her own local copy on his/her device.

The systems and methods use a push message and a local copy at each member to update shared information even without using a cloud service, such as in the peer-to-peer scenario. A push message or notice is sent automatically from a member device upon updating information. The system then pulls the updated information from the member. The pull action is done automatically, e.g., when a device is turned on or connected to a network. In an embodiment, the system gets the newest information by pulling the information from any device which has the newest information in the group without a cloud service, e.g., via a peer-to-peer connection. A copy is kept by each member locally on his/her device for use at any time. This scheme allows all members of the group to have the newest information, which they can share and use locally, without loss of information updates.

Regardless whether the members' device is turned on or off and whether the members' device is connected or disconnected from the network during the information update, the updated information is pushed to the members' mobile devices when it is possible (e.g., when the device becomes turned on and/or connected). When the user's device is turned on or connected to the network, the device automatically checks and pulls the newest information from the system.

The sharing can be applied to the member's associated information and other commonly used information by the members (e.g. contacts, calendar, documents, project status, customer contact number or order status, photos, multimedia files, playlists, memos, notes). Further, permission controls can be supported to determine access permission to users. For instance, if a member leaves the group, the other present members delete from their devices their local copies of the commonly shared information of the leaving member.

FIG. 1 shows an embodiment of a system 100 for automatically sharing, synchronizing and collaboration of information between electronic devices, using a cloud environment. The devices and servers of the system 100 work together to automatically share and synchronize information. At step 1, one of the devices, e.g., Device 1, updates the local copy of the information, and then uploads it to one or more servers in the cloud. This step is performed automatically by a client (e.g., a software application) in Device 1. At step 2, the one or more servers in the cloud push a message to all the other present devices in the group. The push message serves as a notice to the devices of the updated information in Device 1. In one implementation, the servers can also track the push message to determine whether the message arrives to the destination devices. For example, the devices can be configured to send acknowledgments to the servers upon receiving the push message. In yet another implementation, the servers send the push message without tracking, e.g., without checking if the message arrives to the destinations or is lost. At step 3, when the present devices receive the push message, the devices synchronize the information with the servers in the cloud automatically via the clients on the devices.

If at the time of sending the push messages, another device, e.g., Device 2, is turned off or disconnected from a network for the devices (e.g., the cloud or the Internet), then Device 2 can lose the push message, which is the notice for the information update. Therefore, at step 4, when Device 2 is then turned on or connects to the network, Device 2 requests or gets from the servers in the cloud the date of the newest information. At step 5, the servers in the cloud send the date to Device 2. At step 6, if Device 2 does not have the newest information according to the date, it synchronizes the information with the servers in the cloud automatically. This can also cause an update with other devices via the push mechanism as described above. Otherwise, if there is no new information at Device 2, then Device 2 does not need to act.

FIG. 2 shows more details of the cloud based information sharing and updating system 100 described above. Specifically, more details of the system components and steps above of the system 100 are described. At step 1 above, when Device 1 updates its local copy of the information, a commonly sharing information management component 101 (e.g., a software application), which is a part of the client on Device 1, checks the changes, and then uploads the changes to an update service 102 (e.g., a software application) at a server in the cloud automatically. At step 2 above, the update service 102 of the server updates the copy in the server, and requests from a notice sender 103 (e.g., a software application) to push a message as a notice to the notice receivers 105 at the other devices in the group automatically. The servers may track the push message or may be unaware whether the push messages are received or lost, according to different implementations. In the case of tracking the message, the notice sender 103 asks a notice tracker 104 at the server to wait for feedback from the notice receiver 105.

If the notice receiver 105 of another device receives the push message, a synchronizing module 106 at the device synchronizes the information with the servers at step 3 above automatically. The synchronizing module 106 sends a request to a commonly sharing information provider 107 at the server, pulls the information from the commonly sharing information provider 107, and then updates the copy of the information at the other device. If the server is configured to track the push message, the notice receivers 105 of the devices send the feedback to the notice tracker 104 at the server automatically. If at the time of synchronization, another device, e.g., Device 2, is turned off or disconnected from the network, Device 2 may lose the push message. Therefore, at step 4 above, when Device 2 is turned on or reconnects to the network, the commonly sharing information management component 101 in Device 2 asks the update service 102 of the server in the cloud to get the date of the newest information automatically.

At step 5 above, the update service 102 of the server sends the date to the synchronizing module 106 in Device 2. At step 6 above, the synchronizing module 106 checks if the date is newer than the date of the copy in Device 2. If the date is newer, the synchronizing module 106 synchronizes the information with the servers in the cloud automatically. The synchronizing module 106 sends a request to the commonly sharing information provider 107 at a server, pulls the information from the commonly sharing information provider 107, and then updates the copy of the information at Device 2. As such, the user of Device 2 does not lose the newest updated information even if the device was offline or disconnected at the time of initial synchronization.

The different components or functions above of the system 100 can be implemented at the devices and the servers via software, hardware, or both. While one server is shown in FIG. 2, a plurality of servers can implement jointly the steps above to communicate with the devices. Any server can communicate with any of the devices if applicable. The choice of which servers to communicate with which devices can be subject to system criteria or constraints and is outside the scope of this disclosure. Additionally, the servers can communicate with each other to synchronize all updated information and to synchronize their communications with the members' devices.

FIGS. 3A and 3B show an embodiment of a method 300 for sharing, synchronizing and collaboration of information between electronic devices. The method 300 can be implemented by the cloud based system 100 described above. Specifically, in the method 300, the server in the cloud tracks does not track whether the push message is lost or received by the devices. At step 301, a first user (User 1) updates information in his/her local copy on his/her device. At step 302, a client on the user's device determines if the information (e.g., documents and/or data) should be marked for sharing or not. If the information is marked for sharing, then at step 303 the client checks the new or updated information and any conflict with any one of the servers in the cloud. At step 304, the client determines whether the information should be synchronized between the server and the device or not. If there information should be synchronized, then at step 305, the client uploads the new information to the server. At step 306, the server, after receiving the upload, sends a push message to the other devices in the group. At step 307, the clients on the devices of the group detect whether a push message is received. If the push message is received, then at step 314 each client synchronizes its local copy of the information (e.g., documents and/or data) with the corresponding information in the server of the cloud. The synchronization may be limited to the newest or updated information with respect to each device. The synchronization includes checking whether the copies are marked to be shared. For this reason a time or date stamp can be used to compare the copies. A synchronization protocol can be used to avoid conflict in the copies between the devices and the server. At step 315, the user can use on its device the newest copy of information. Additionally, at step 312, a device of the group may be turned on (by its user) or connect to the network (e.g., the Internet or the cloud). Hence, at step 313, the client of this device checks with the server if the device has the newest information. If this is not true, then the synchronization of step 314 is performed for this device.

FIGS. 4A, 4B and 4C show an embodiment of a method 400 for sharing, synchronizing and collaboration of information between electronic devices. The method 400 can be implemented by the cloud based system 100 described above. Specifically, in the method 400, the server in the cloud tracks whether the push message is lost or received by the devices. The method 400 includes the same steps 301 to 307 and 314 to 315 described above. To track the push message after the server sends the push message to the devices at step 306, the server waits at step 408 for a confirmation or acknowledgement message from each device. At step 409, the server detects whether the confirmation message is received. If the message is received, then the server does not react. Otherwise, if the confirmation message is not received, the server marks which device did not receive the push message (e.g., which device did not send back the confirmation message). At step 411, the mark is stored in a database, which can be checked by any device that is turned on or reconnects to the network. For instance, at step 312, a device of the group may be turned on (by its user) or connect to the network. At step 413, the client of this device and the server check if there is a push message marked by the server for this device. If this is true, then the synchronization of step 314 is performed for this device.

FIG. 5 shows an embodiment of a system 500 for sharing, synchronizing and collaboration of information between electronic devices, using a peer-to-peer network or connection. In one group, when a member device updates its information for sharing, other member devices automatically synchronize and update the information between the devices, such as mobile phones, smartphones, wearable devices, or other suitable devices, via peer-to-peer links between the devices. Thus, the system 500 can be implemented without using a cloud service. A server on each device provides the update service. Each member can synchronize and update the information that needs updating via a client on the member's device, for example using a Transmission Control Protocol (TCP)/Internet Protocol (IP)/Peer-to-Peer (P2P) Protocol. If a member device updates its information that needs sharing, the server in the device can push a message directly to all other devices of the members in the group. Hence, the clients in the devices of other members synchronize and update this information with the server of the updating device.

When a device is turned on or connects to a network (e.g., a peer-to-peer network), the client in the device gets the information date stamp from other peer-to-peer devices in the group and checks if the date stamp of its local copy of the information is the same as in the other devices. If the local information date is older than the date in another device, the checking device pulls the information from another peer device. This action is taken in the case the checking device did not receive the push message when it was turned off or disconnected from the network. As such, the user would not lose the newest updated information even if its device was offline or turned off. The device automatically checks and pulls the newest information (e.g., by comparing the date stamps from different devices) when it is turned on or connects to the network. According to the synchronization protocol implemented, the device can choose to only pull the modified portion. If a member leaves the group, the other members can delete the copy of the commonly shared information of the device of the leaving member.

The devices and servers of the system 500 work together to automatically share and synchronize information. At step 1, a device, e.g., Device 1, updates the local copy of the information, and then the server in Device 1 pushes a message as a notice to all the other devices in the group automatically. If the other devices receive the push message, the clients at the devices synchronize the information with the server in Device 1 at step 2. If at that time, a device, e.g., Device 2, is turned off or disconnected from the network, that device does not receive the push message. Therefore, when Device 2 is turned on or connects to a network of the devices, the client of Device 2 asks the servers in the other devices of the group to get the date of the newest information at step 3 automatically. Device 2 can select one, two or more of other devices from the group to get the date information. The servers in the selected devices then send the date to Device 2 at step 4. If Device 2 does not have the newest information, it synchronizes the information with the server in the device that has the newest information at step 5 automatically.

FIG. 6 shows more details of the peer-to-peer based information sharing and updating system 500 described above. Specifically, more details of the system components and steps are described. At step 1 above, Device 1 updates the local copy of the information. A commonly sharing information management component 101 of the client in Device 1 then checks the changes automatically, and asks a notice sender 103 of the server in Device 1 to push a message as a notice to the notice receivers 105 at the clients at the other devices in the group automatically. If the notice receivers 105 of the clients in the other devices receive the push message, the notice receivers 105 ask a synchronizing module 106 of the clients in the same devices to synchronize the information with the server in Device 1 at step 2 above, automatically. The synchronizing module 106 sends a request to a commonly sharing information provider 107 of the server in Device 1, pulls the information from the commonly sharing information provider 107 of the server in Device 1, automatically, and then updates the copy of the information locally.

If at the time of synchronization, e.g., Device 2, is turned off or disconnected from the network, it may lose the push message. Therefore, when Device 2 is turned on or connects to the network of the devices, the commonly sharing information management component 101 in Device 2 asks the commonly sharing information provider 107 of the server in other devices to get the date of the newest information at step 3 above, automatically. Device 2 can select one, two or more other devices to get the date. The commonly sharing information provider 107 of the server in the selected devices sends the date to a synchronizing module 106 at the client in Device 2 at step 4 above. The synchronizing module 106 checks if the date is newer than the date of the copy in Device 2. The synchronizing module 106 finds the newest date from the dates of the information at the selected devices, and then marks the device which has the newest date of information, e.g. sets that device as a Good Device. The synchronizing module 106 synchronizes the information with the server in the Good Device at step 5 above, automatically. If the newest date of the selected device (Good Device) is newer than the date of the information in Device 2, then, the synchronizing module 106 sends a request to the commonly sharing information provider 107 of the server in the Good Device, pulls the information from the commonly sharing information provider 107 of the server in the Good Device, and then updates the copy of the information locally. As such, the user of Device 2 would not lose the newest updated information even if Device 2 was offline during the initial synchronization.

However, if the newest date of the selected device (Good Device) is the same as the date of the information in Device 2, then the synchronizing module 106 can repeat the step 5 by searching again for the newest date from the dates of the information at the selected devices as. Repeating step 5 serves as a verification of the step. If the new found date is still the same, then the synchronization can end. If the new found date is older than the previously found date, then the step 5 or step 3 can be repeated.

FIGS. 7A, 7B and 7C show an embodiment of a method 700 for sharing, synchronizing and collaboration of information between electronic devices. The method 700 can be implemented by the peer-to-peer based system 500 described above. At step 701, a first user (User 1) updates information in his/her local copy on his/her device. At step 702, a client on the user's device determines if the information (e.g., documents and/or data) should be marked for sharing or not. If the information is marked for sharing, then at step 703 the client checks the address of all other devices in the group using a P2P protocol. At step 704, the client sends a push message to the other devices in the group. At step 705, the clients on the devices of the group detect whether a push message is received. If the push message is received, then at step 711 each client synchronizes the copy of information (e.g., documents and/or data) on its device with a copy from the server in the device of User 1. A synchronization protocol can be used to avoid conflict in the copies. The P2P protocol provides the transfer method for the information between the devices. If the server in the device of User 1 is turned off or the device is disconnected, then the client selects a next server which meets the needs (has the newest information). At step 712, the user can use on its device the newest copy of information. Additionally, at step 706, a device of the group may be turned on (by its user) or connect to the network or the devices. Hence, at step 707, the client of this device selects two or more servers on other devices of the group. At step 708, the client gets the date of the information copy in the two or more servers. At step 709, the client compares the dates between the copy on the device and the obtained copies of the selected devices. If the device does not have the newest information (the copy of the latest date), then at step 710 the client finds the server with the newest information in the selected devices, for example to obtain the updated information in the device of User 1. The server may belong to the device of User 1 or to any of the other devices that have updated the copy of the information accordingly during the synchronization step 711. After the client finds a server with the newest information at step 710, the client performs the synchronization step 711 with that server.

FIG. 8 shows a mobile communications device 800 that may be used to implement the system and method for sharing, synchronizing and collaboration of information disclosed herein. The mobile communications device 800 may comprise a processor 820 (which may be referred to as a central processor unit or CPU) that is in communication with memory devices including secondary storage 821, read only memory (ROM) 822, and random access memory (RAM) 823. The processor 820 may be implemented as one or more general purpose CPU chips, one or more cores (e.g., a multi-core processor), or may be part of one or more application specific integrated circuits (ASICs) and/or digital signal processors (DSPs). The processor 820 may be configured to implement any of the schemes described herein, and may be implemented using hardware, software, firmware, or combinations thereof.

The secondary storage 821 may be comprised of one or more solid state drives, disk drives, and/or other memory types and is used for non-volatile storage of data and as an over-flow data storage device if RAM 823 is not large enough to hold all working data. Secondary storage 821 may be used to store programs that are loaded into RAM 823 when such programs are selected for execution. The ROM 822 may be used to store instructions and perhaps data that are read during program execution. ROM 822 may be a non-volatile memory device may have a small memory capacity relative to the larger memory capacity of secondary storage 821. The RAM 823 may be used to store volatile data and perhaps to store instructions. Access to both ROM 822 and RAM 823 may be faster than to secondary storage 821.

The mobile communications device 800 may communicate data (e.g., packets) wirelessly with a network via a network access point 850. As such, the mobile communications device 800 may comprise a receiver (Rx) 812, which may be configured for receiving data (e.g. wireless packets or frames) from other components. The receiver 812 may be coupled to the processor 820, which may be configured to process the data and determine to which components the data is to be sent. The mobile communications device 800 may also comprise a transmitter (Tx) 832 coupled to the processor 820 and configured for transmitting data to other components, for example by using protocols such as Institute of Electrical and Electronics Engineers (IEEE) 802.11, IEEE 802.16, 3rd Generation Partnership Project (3GPP), Global System for Mobile Communications (GSM), or similar wireless protocols. The receiver 812 and transmitter 832 may be coupled to at least one antenna 830, which may be configured to receive and transmit wireless radio frequency (RF) signals. In some embodiments, Tx 832 and Rx 812 may be replaced by a transceiver comprising the functionality of both Tx 832 and Rx 812.

The mobile communications device 800 may also comprise a display device 840 coupled to the processor 820, that displays output thereof to a user. The mobile communications device 800 and the display device 840 may configured to display representations of data to a user. The display device 840 may comprise a color super twisted nematic (CSTN) display, a thin film transistor (TFT) display, a thin film diode (TFD) display, an organic light-emitting diode (OLED) display, an active-matrix OLED display, or any other display screen. The display device 840 may display in color or monochrome and may be equipped with a touch sensor based on resistive and/or capacitive technologies.

The mobile communications device 800 may further comprise an input device 841 coupled to the processor 820, which may allow the user to input commands to the mobile communications device 800. In the case that the display device 840 comprises a touch sensor, the display device 840 may also be considered the input device 841. In addition to and/or in the alternative, an input device 841 may comprise a mouse, trackball, built-in keyboard, external keyboard, and/or any other device that a user may employ to interact with the mobile communications device 800.

It is understood that by programming and/or loading executable instructions onto the mobile communications device 800, at least one of the processor 820, memory 821-623, and/or Rx/Tx 812/632 are changed, transforming the mobile communications device 800 in part into a particular machine or apparatus, e.g., a mobile communications device having novel and adaptive reconfiguration characteristics. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method performed by a communication device for sharing, synchronizing and collaboration of information among a group of members, the method comprising:
updating information located on the communication device associated with one of the members;
determining whether the information is marked for sharing with the members of the group;
upon detecting that the information is marked for sharing, automatically comparing the updated information with a copy of the information at a server in a network; and
upon detecting that the updated information is newer than the copy of the information at the server, uploading the updated information to the server via a cloud service.

2. The method of claim 1 further comprising:
upon one of turning on the communication device and connecting the communication device to the network, automatically checking with the server whether there is newer sharable information at the server than a corresponding copy on the communication device; and
upon detecting the newer sharable information at the server, synchronizing the corresponding copy on the communication device with the newer sharable information at the server.

3. The method of claim 1 further comprising:
receiving a push message from the server, the push message notifying the communication device of new sharable information at the server; and
upon detecting the new sharable information is newer than the copy at the communication device, synchronizing the new sharable information at the server with the corresponding copy at the communication device.

4. The method of claim 3 further comprising upon receiving the push message, sending to the server a notification message confirming the receiving of the push message.

5. The method of claim 1 further comprising:
upon one of turning on the communication device and connecting the communication device to the network, automatically checking with the server whether there is a push message marked to be sent to the communication device; and
upon detecting the push message is marked for the communication device, synchronizing new sharable information at the server with a corresponding copy at the communication device.

6. A method performed by a communication device for sharing, synchronizing and collaboration of information among a group of members, the method comprising:
updating information located on the communication device;
determining whether the information is marked for sharing with the members of the group;
upon detecting that the information is marked for sharing, detecting devices associated with other members of the group using a peer-to-peer protocol; and
sending a push message to the devices of the other members via the peer-to-peer protocol, the push message notifying the devices that the information at the communication device has been updated.

7. The method of claim 6 further comprising:
receiving a push message from a device of another member of the group via the peer-to-peer protocol, the push message notifying the communication device of new sharable information at the device; and
synchronizing the new sharable information at the device with a corresponding copy at the communication device.

8. The method of claim 6 further comprising:
upon one of turning on the communication device and connecting the communication device to one of the devices of the other members, selecting a plurality of the devices;
checking with the selected devices whether there is new sharable information at the devices; and
upon detecting the new sharable information at least at one of the devices, synchronizing the new sharable information at the at least one of the devices with a corresponding copy on the communication device.

9. The method of claim 8, wherein the checking includes comparing date and time for local copies of sharable information at the devices and the communication device.

10. A method performed by a server supporting sharing, synchronizing and collaboration of information among a group of members, the method comprising:
receiving, via a cloud service, updated information from a device associated with a member of the group, wherein the update information is sharable by the members of the group;
sending a push message to other devices of other members of the group, the push message notifying the other members of the updated information at the device; and
synchronizing the updated information with corresponding copies at the other devices.

11. The method of claim 10 further comprising:
determining whether a notification message is received from each one of the other devices; and
upon detecting an unreceived notification message from one of the other devices, marking the one of the devices as an unnotified device in a database of the cloud service.

12. The method of claim 10 further comprising:
upon detecting a new connection from one of the devices of the members of the group, checking whether there is a push message marked to be sent to the one of the devices; and
upon detecting a marked push message for the one of the devices, synchronizing new sharable information at the server with a corresponding copy at the one of the devices.

13. The method of claim 10 further comprising:
upon detecting a new connection from one of the devices of the members of the group, checking with the one of the devices whether there is newer sharable information at the server than a corresponding copy on the one of the devices; and
upon detecting the newer sharable information at the server, synchronizing the newer sharable information at the server with the corresponding copy on the one of the devices.

14. A communication device supporting sharing, synchronizing and collaboration of information among a group of members, the communicating device comprising:
at least one processor; and
a non-transitory computer readable storage medium storing programming for execution by the at least one processor, the programming including instructions to:
update information located on the communication device associated with one of the members;
determine whether the information is marked for sharing with the members of the group;
upon detecting that the information is marked for sharing, compare the updated information with a copy of the information at a server in a network; and
upon detecting that the updated information is newer than the copy of the information at the server, upload the updated information to the server via a cloud service.

15. The communication device of claim 14, wherein the instructions includes instructions to:
upon one of turning on the communication device and connecting the communication device to the network, check with the server whether there is newer sharable information at the server than a corresponding copy on the communication device; and
upon detecting the newer sharable information at the server, synchronize the corresponding copy on the communication device with the newer sharable information at the server.

16. The communication device of claim 14, wherein the instructions includes instructions to:
receive a push message from the server, the push message notifying the communication device of new sharable information at the server; and
synchronize the new sharable information at the server with a corresponding copy at the communication device.

17. The communication device of claim 14, wherein the instructions includes instructions to:
upon one of turning on the communication device and connecting the communication device to the network, check with the server whether there is a push message marked to be sent to the communication device; and
upon detecting the push message is marked for the communication device, synchronize new sharable information at the server with a corresponding copy at the communication device.

18. A communication device supporting sharing, synchronizing and collaboration of information among a group of members, the communicating device comprising:
at least one processor; and
a non-transitory computer readable storage medium storing programming for execution by the at least one processor, the programming including instructions to:
update information located on the communication device;
determine whether the information is marked for sharing with the members of the group;
upon detecting that the information is marked for sharing, detect devices associated with other members of the group using a peer-to-peer protocol; and
send a push message to the devices of the other members via the peer-to-peer protocol, the push message notifying the devices that the information at the communication device has been updated.

19. The communication device of claim 18, wherein the instructions includes instructions to:
receive a push message from a device of another member of the group via the peer-to-peer protocol, the push message notifying the communication device of new sharable information at the device; and
synchronize the new sharable information at the device with a corresponding copy at the communication device.

20. The communication device of claim 18, wherein the instructions includes instructions to:
upon one of turning on the communication device and connecting the communication device to one of the devices of the other members, select a plurality of the devices;
check with the selected devices whether there is new sharable information at the devices; and
upon detecting the new sharable information at least at one of the devices, synchronize the new sharable information at the at least one of the devices with a corresponding copy on the communication device.

21. A network server supporting sharing, synchronizing and collaboration of information among a group of members, the network server comprising:
at least one processor; and
a non-transitory computer readable storage medium storing programming for execution by the at least one processor, the programming including instructions to:
receive, via a cloud service, updated information from a device associated with a member of the group, wherein the update information is sharable by the members of the group;
send a push message to other devices of other members of the group, the push message notifying the other members of the updated information at the device; and
synchronize the updated information with corresponding copies at the other devices.

22. The network server of claim 21, wherein the instructions includes instructions to:
determine whether a notification message is received from each one of the other devices; and
upon detecting an unreceived notification message from one of the other devices, mark the one of the devices as an unnotified device in a database of the cloud service.

23. The network server of claim 21, wherein the instructions includes instructions to:
upon detecting a new connection from one of the devices of the members of the group, check whether there is a push message marked to be sent to the one of the devices; and
upon detecting a marked push message for the one of the devices, synchronize new sharable information at the network server with a corresponding copy at the one of the devices.

24. The network server of claim 21, wherein the instructions includes instructions to:
upon detecting a new connection from one of the devices of the members of the group, check with the one of the devices whether there is newer sharable information at the network server than a corresponding copy on the one of the devices; and
upon detecting the newer sharable information at the network server, synchronize the newer sharable information at the network server with the corresponding copy on the one of the devices.
